(19) United States
(12) Patent Application Publication
(10) Pub. No.: US 2023/0061605 A1
(43) Pub. Date: Mar. 2, 2023

(54) SYSTEMS AND METHODS FOR INTELLIGENT FRAUD DETECTION

(71) Applicant: JPMORGAN CHASE BANK, N.A., New York, NY (US)

(72) Inventors: Una RYAN, Dublin (IE); Matthew TAKAMATSU, Tampa, FL (US); Uri KLEIN, New York, NY (US); Jag PHULLAR, LONDON (GB); Rodrigo PERALTA, Dublin (IE); Rubina MADHAVAN, Dublin (IR); Ayman A HAMMAD, Pleasanton, CA (US); Tanmay SALUNKHE, Mumbai (IN)

(21) Appl. No.: 17/822,359

(22) Filed: Aug. 25, 2022

Related U.S. Application Data
(60) Provisional application No. 63/237,312, filed on Aug. 26, 2021.

(51) Int. Cl. G06Q 20/40; G06Q 20/38

(52) U.S. Cl. CPC G06Q 20/4016; G06Q 20/389

(57) ABSTRACT

A method for fraud detection and management may include a fraud detection computer program: receiving data from a plurality of sources, each data associated with a unique identifier; normalizing the data; modeling the normalized data with a trained machine learning data model; extracting features or attributes from the modeled data; generating one or more sets of weights for the features or attributes; identifying a subset of the features or attributes indicative of fraud based on the weights; enriching the subset of the features or attributes; detecting fraud based on the enriched subset of the features or attributes; and notifying one or more subscribing institutions of a fraud event for the detected fraud based on the validated subset of the features or attributes.

### RELATED APPLICATIONS

This application claims priority to, and the benefit of, U.S. Provisional Patent Application Ser. No. 63/237,312, filed Aug. 26, 2021, the disclosure of which is hereby incorporated, by reference, in its entirety.

### BACKGROUND OF THE INVENTION

### 1. Field of the Invention

The present disclosure generally relates to systems and methods for intelligent fraud detection.

### 2. Description of the Related Art

As electronic devices and digital wallets without physical payment mechanisms continue to grow, digital fraud has become more complex and sophisticated. The technical sophistication of fraud detection mechanisms are challenged to scale and provide robust detection. Issuers, acquirers, and merchants typically do not share fraudulent activity in real time with one another. Even though issuers and merchants deploy sophisticated fraud and risk management solutions, each solution is designed to manage different and individualized risks and prevents sharing and validation of underlying fraudulent signals that could reduce fraud in real time.

### SUMMARY OF THE INVENTION

Systems and methods for fraud detection and management are disclosed. The method includes receiving merchant data, acquiring data, issuer data and third-party data indicative of payments or identity fraud. The method may further include generating an anonymized and normalized data set, wherein the generating comprises normalizing the merchant data, acquiring data, and issuer data. The method may further include enriching the normalized data set. The method may further include performing data modeling based on the normalized data set. The method may further include detecting fraud based on the data modeling. The method may further include notifying a fraud network member of a fraud event based on the fraud detection method.

According to an embodiment, a method for fraud detection and management may include: receiving, by a fraud detection computer program, data from a plurality of sources, each data associated with a unique identifier; normalizing, by the fraud detection computer program, the data; modeling, by the fraud detection computer program, the normalized data with a trained machine learning data model; extracting, by the fraud detection computer program, features or attributes from the modeled data; generating, by the fraud detection computer program, one or more sets of weights for the features or attributes; identifying, by the fraud detection computer program, a subset of the features or attributes indicative of fraud based on the weights; enriching, by the fraud detection computer program, the subset of the features or attributes; detecting, by the fraud detection computer program, fraud based on the enriched subset of the features or attributes; and notifying, by the fraud detection program, one or more subscribing institutions of a fraud event for the detected fraud based on the validated subset of the features or attributes.

In one embodiment, the data may include merchant data, acquirer data, issuer data, and/or payment network data.

In one embodiment, the method may also include anonymizing, by the fraud detection computer program, the normalized data.

In one embodiment, the step of normalizing the data may include: converting, by the fraud detection computer program, the data into one or more vectors; and scaling, by the fraud detection computer program, the vectors to a standardized unit.

In one embodiment, the method may also include validating, by the fraud detection computer program, that the subset of the features or attributes are indicative of an acceptable fraud event.

In one embodiment, the subset of the features or attributes may be validated using dispute data, auxiliary fraud data, card scheme dispute data, and/or historical consortium data.

In one embodiment, the subset of the features or attributes may be enriched with historical data relating to an issuer, a merchant, an acquirer, and/or a type of financial instrument.

In one embodiment, the data may be received from a common data repository or from a distributed ledger network.

According to another embodiment, a system may include a plurality of data sources, a fraud management computer network executing a fraud detection computer program, and a plurality of subscribing institutions. The fraud detection computer program may receive data from the plurality of data sources, each data associated with a unique identifier, may normalize the data, may model the normalized data with a trained machine learning data model, may extract features or attributes from the modeled data, may generate one or more sets of weights for the features or attributes, may identify a subset of the features or attributes indicative of fraud based on the weights, may enrich the subset of the features or attributes, may detect fraud based on the enriched subset of features or attributes, and may notify one or more subscribing institutions of a fraud event for the detected fraud based on the validated subset of features or attributes.

In one embodiment, the data may include merchant data, acquirer data, issuer data, and/or payment network data.

In one embodiment, the fraud detection computer program may anonymize the normalized data.

In one embodiment, the fraud detection computer program may normalize the data by converting the data into one or more vectors and scaling the vectors to a standardized unit.

In one embodiment, the fraud detection computer may validate that the subset of the features or attributes are indicative of an acceptable fraud event. The subset of the features or attributes may be validated using dispute data, auxiliary fraud data, card scheme dispute data, and/or historical consortium data.

In one embodiment, the subset of the features or attributes may be enriched with historical data relating to an issuer, a merchant, an acquirer, an/or a type of financial instrument.

In one embodiment, the data may be received from a common data repository or from a distributed ledger network.

In one embodiment, a non-transitory computer readable storage medium, may instructions stored thereon, which when read and executed by one or more computer processors, cause the one or more computer processors to perform steps including: receiving data from a plurality of sources, each data associated with a unique identifier, wherein the data comprises merchant data, acquirer data, issuer data, and/or payment network data; normalizing the data by converting the data into one or more vectors and scaling the vectors to a standardized unit; modeling the normalized data with a trained machine learning data model; extracting features or attributes from the modeled data; generating one or more sets of weights for the features or attributes; identifying a subset of the features or attributes indicative of fraud based on the weights; enriching the subset of the features or attributes with historical data relating to an issuer, a merchant, an acquirer, an/or a type of financial instrument; detecting fraud based on the enriched subset of the features or attributes; and notifying one or more subscribing institutions of a fraud event for the detected fraud based on the validated subset of the features or attributes.

In one embodiment, the non-transitory computer readable storage may also include instructions stored thereon, which when read and executed by one or more computer processors, cause the one or more computer processors to anonymize the normalized data.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for detecting and managing fraud, according to an embodiment.

FIG. 2 depicts an example of a method for detecting and managing fraud, according to an embodiment.

FIG. 3 depicts an example of a computing system for implementing certain aspects of the present disclosure.

### DETAILED DESCRIPTION

Embodiments are directed to systems and methods for intelligent fraud detection. In embodiments, a fraud management network may receive issuer data, acquiring data, merchant data, and/or third-party data over a plurality of channels. The fraud management network itself, or through third party data sources, may enrich the data and validate the occurrence of a fraud event. The fraud management system may also notify a fraud network member, such as a participating bank, of the fraud event based on validating and enriching attributes associated with the fraud event.

Embodiments may mitigate fraudulent behavior by providing a real-time data aggregation and privileged sharing framework.

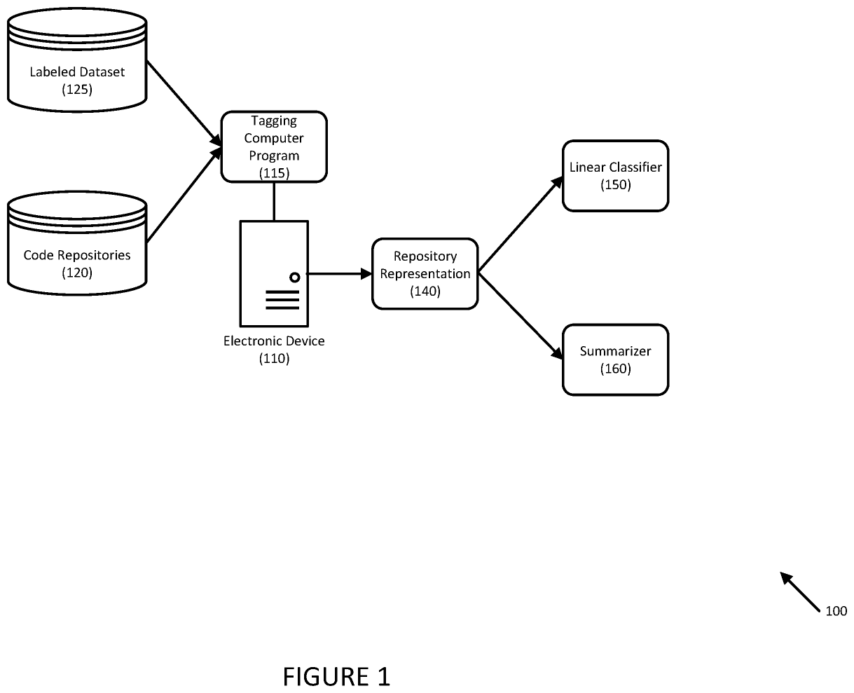

Referring to FIG. 1, a system for detecting and managing fraud is disclosed according to an embodiment. System 100 may include fraud management network 110, common data repository, distributed ledger network 130, subscribing institutions 140, consumer electronic device(s) 160, external data source(s) 170, and network 180. It should be noted that these entities are exemplary only; additional, fewer, and/or different entities may be provided as is necessary and/or desired.

Fraud management network 110 may be communicatively coupled to consumer electronic device(s) 160. Fraud management network 110 may include fraud detection program 112, third party data module 114, and data model 116. In one example, fraud detection program 112 may be executed in fraud management network 110, or may be configured as a distributed application that is executed by a fraud management network.

Fraud management network 110 may receive data from external data sources 170, which may include merchants, acquirers, issuing financial institutions, payment networks, fraud detection entities, identity verification entities, geo-location providers, social media websites, financial websites, credit reporting data sources, public records, etc. The data may be received over one or more business channels. Once ingested, enriched, and validated, the data may be stored in common data repository 120 as, for example, merchant data 122, issuer data 124, acquiring data 126, network data 128, etc. Additional and/or different data stores may be provided as is necessary and/or desired.

Merchant data 122 may include, for example, a merchant risk score, shipping data, type of merchandise, age of merchant account, type of transactions associated with the merchant, return or refund history, a restricted merchant list, etc.

Issuer data 124 may include, for example, customer billing addresses, electronic mail addresses, trusted electronic device identifiers, dispute history, reported fraud history, risk scores, compromised financial instrument history, transaction decline history, etc.

Acquiring data 126 may include, for example, card fraud history, pre-sale risk signals, behavioral and device indicators, aggregated merchant and card data, etc.

Network data 128 may include, for example, aggregated authorization data, aggregated address, card present data, etc.

In one embodiment, the data may be protected or encrypted as appropriate for compliance with the applicable local rules, regulations, or security/privacy policies.

Alternatively, or in addition, data from external data sources 170 may be written to distributed ledger network 130. Distributed ledger network 130 may be blockchain-based network, and may include nodes (not shown) that provide merchant data, issuer data, acquiring data, and network data.

In one embodiment, one or more of merchants, acquirers, issuing financial institutions, payment networks, fraud detection entities, identity verification entities, geo-location providers, social media websites, financial websites, credit reporting data sources, public record sources, etc. may participate as nodes in distributed ledger network 130.

Consumer electronic devices 160 may be any suitable electronic devices, including computers (e.g., workstations, desktops, notebooks, laptops, tablets, etc.), smart devices, Internet of Things (IoT) devices, etc. Consumer electronic device(s) 160 may include interface 162, such as a graphical user interface, that may provide an interface for receiving input from a user of consumer electronic device 160 to fraud management network 110 via network 180. Consumer electronic device(s) 160 may also receive notifications, such as a fraud detection alert from fraud management network 110, and may present the notifications via interface 162.

System 100 may further include subscribing institutions 140 (e.g., subscribing institution 140ₖ, subscribing institution 140₂, . . . subscribing institution 140ₙ). Subscribing institutions 140 may include any suitable entity, including financial institutions, FinTechs, merchants, individuals, etc. In one embodiment, subscribing institutions 140 may receive alerts regarding fraudulent activity, or may submit transactions to determine a likelihood of fraudulent activity. Thus, in embodiments, fraud management network 110 may provide fraud assessment as a service to subscribing institutions 140.

Third party data module 114 may be configured to receive information from external data sources 170.

Data model 116 may be a trained machine learning model that may be configured to analyze data in common data repository 120 and/or distributed ledger network 130, including merchant data 122, issuer data 124, acquirer data 126 network data 128, and third-party data. Data model 116 may be trained using supervised, semi-supervised, or unsupervised training.

In one embodiment, transactional attributes in the merchant data 122, issuer data 124, acquirer data 126 network data 128, and third-party data indicative of fraud may be identified based on their historical significance or current ability to detect fraud.

Fraud detection computer program 112 may be configured to detect a fraud event based on the output of data model 116. Fraud detection module 112 may compare the fraud likelihood to a threshold level for fraud likelihood, or with a historical fraud threshold. Fraud detection module 112 may generate a notification of the fraud event and communicate the notification to one or more subscribing institutions 140.

Fraud detection module 112 may further determine a type or location of the fraud event based on the output of data model 116. In some embodiments, fraud detection module 112 may also be configured to share a portion of issuer data 124, acquiring data 126, merchant data 122, third party data, and/or the enriched data with one or more subscribing institutions 140 (e.g., subscribing institution 140ₖ, subscribing institution 140₂, . . . subscribing institution 140ₙ) that may be authenticated and verified prior to providing the portion of data.

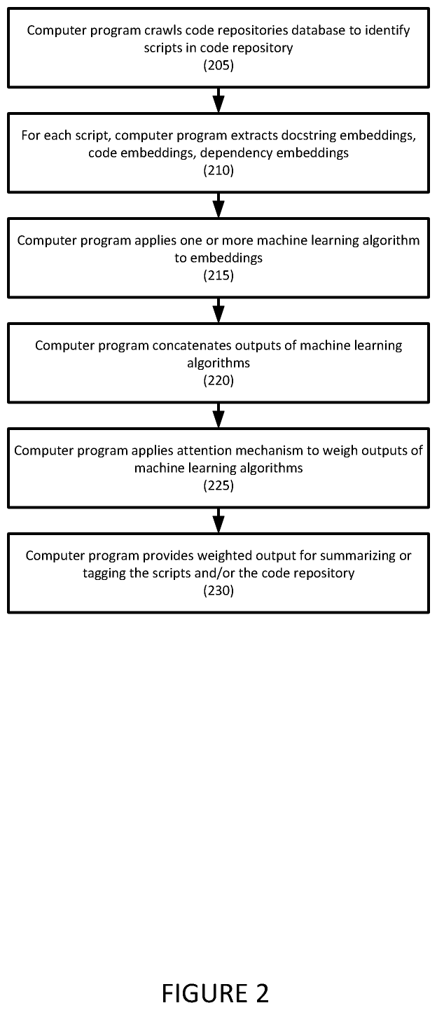

FIG. 2 depicts a method for intelligent fraud detection according to an embodiment.

In step 205, a computer program, such as a fraud detection computer program, may receive data from a plurality of data sources, such as merchants, acquirers, issuers, payment networks, fraud detection entities, identity verification entities, geo-location providers, social media websites, financial websites, credit reporting data sources, public records, customer electronic devices, etc. The data may be received over a plurality of business channels as merchant data, acquirer data, issuer data, payment network data, etc. Each set of data may be associated with any type of sourced or generated unique identifier for a related transaction.

In step 210, the fraud detection computer program may normalize and anonymize the data. For example, the fraud detection computer program may convert the merchant data, the acquirer data, the issuer data, the payment network data, etc. into one or more vectors and may scale the vectors to a standardized unit representing the highest derived accuracy. The fraud detection computer program may perform additional pre-processing steps based on the type of the data model to be used. For example, the fraud detection computer program may format the data for a particular data model.

The fraud detection computer program may also adjust the pre-processing steps based on outcomes and feedback from, for example, the fraud detection module.

In step 215, the fraud detection computer program may model the normalized data set using, for example, a trained machine learning data model. The data model may extract one or more sets of features or attributes from the data set, generate one or more sets of weights, and identify a subset of the features or attributes that are indicative of a likelihood of fraud based on the enriched data set. The data model may communicate the sets of weights, features, or other indicators of a fraud event to the fraud detection module.

In step 220, the fraud detection computer program may validate that the features or attributes of an issuer, a transaction, a merchant, an acquirer, etc. are accurate and indicative of an acceptable fraud event. For example, the fraud detection computer program may validate the data using, for example, dispute data (which may be internal or from one or more third party), auxiliary fraud data (e.g., any additional or supplementary data that may be used to support the network data), card scheme dispute data (e.g., initial fraud signals that typically originate from a fraud victim), historical consortium data (e.g., data that has been determined to be indicative of fraud that could be used to enrich or validate other data), etc. In one embodiment, the data may be validated using the machine learning models, identifying or associating like or similar historical data or patterns, etc.

In one embodiment, the output of the validation may be a set of validated high-risk attributes. The validated high-risk attributes may be stored in the common data repository.

In step 225, the fraud detection computer program may enrich the features or attributes. In one example, the fraud management network may combine the issuer data, the acquirer data, the merchant data (e.g., data internal to a financial institution's enterprise network), and the external data. For example, the fraud detection computer program may enrich the features or attributes using historical data relating to the issuer, the merchant, the acquirer or the type of financial instrument. One or more algorithms may be applied to the features or attributes to improve their value as information, such as calculating a distance between two points of reference, extracting information behind a specific payment instrument, etc.

In step 230, the fraud detection computer program may detect fraud based on analysis of the enriched features or attributes. The fraud detection module may determine, based on an output of the data model, that a fraud event has been detected. In one example, the fraud detection module may determine the fraud event based on comparing the fraud likelihood to a threshold fraud likelihood, or based on a comparison of historical data.

In one embodiment, the model may be trained using the normalized and validated input data from the plurality of sources against validated fraud outcomes or feedback, or through pattern identification based on the normalized and validated input data.

In step 235, the fraud detection computer program may notify one or more subscribing institutions of a confirmed fraud detection result. For example, the fraud management network may communicate the notification through a peer-to-peer communication, electronic mail, application program interface or the like.

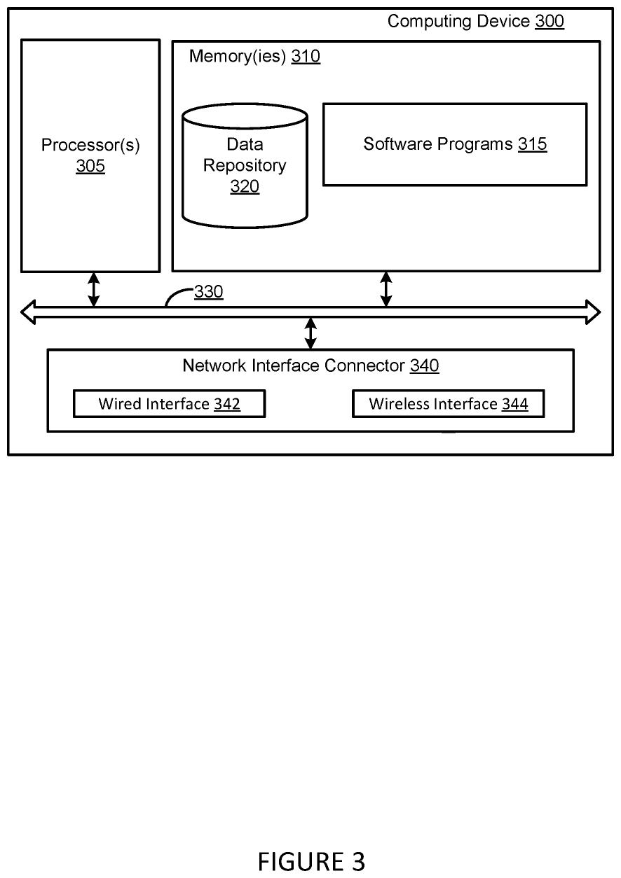

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for fraud detection and management comprising:
receiving, by a fraud detection computer program, data from a plurality of sources, each data associated with a unique identifier;
normalizing, by the fraud detection computer program, the data;
modeling, by the fraud detection computer program, the normalized data with a trained machine learning data model;
extracting, by the fraud detection computer program, features or attributes from the modeled data;
generating, by the fraud detection computer program, one or more sets of weights for the features or attributes;
identifying, by the fraud detection computer program, a subset of the features or attributes indicative of fraud based on the weights;
enriching, by the fraud detection computer program, the subset of the features or attributes;
detecting, by the fraud detection computer program, fraud based on the enriched subset of the features or attributes; and
notifying, by the fraud detection program, one or more subscribing institutions of a fraud event for the detected fraud based on the validated subset of the features or attributes.

2. The method of claim 1, wherein the data comprises merchant data, acquirer data, issuer data, and/or payment network data.

3. The method of claim 1, further comprising:
anonymizing, by the fraud detection computer program, the normalized data.

4. The method of claim 1, wherein the step of normalizing the data comprises:
converting, by the fraud detection computer program, the data into one or more vectors; and
scaling, by the fraud detection computer program, the vectors to a standardized unit.

5. The method of claim 1, further comprising:
validating, by the fraud detection computer program, that the subset of the features or attributes are indicative of an acceptable fraud event.

6. The method of claim 5, wherein the subset of the features or attributes are validated using dispute data, auxiliary fraud data, card scheme dispute data, and/or historical consortium data.

7. The method of claim 1, wherein the subset of the features or attributes are enriched with historical data relating to an issuer, a merchant, an acquirer, an/or a type of financial instrument.

8. The method of claim 1, wherein the data is received from a common data repository.

9. The method of claim 1, wherein the data is received from a distributed ledger network.

10. A system, comprising:
a plurality of data sources;
a fraud management computer network executing a fraud detection computer program; and
a plurality of subscribing institutions;
wherein:
the fraud detection computer program receives data from the plurality of data sources, each data associated with a unique identifier;
the fraud detection computer program normalizes the data;
the fraud detection computer program models the normalized data with a trained machine learning data model;
the fraud detection computer program extracts features or attributes from the modeled data;
the fraud detection computer program generates one or more sets of weights for the features or attributes;
the fraud detection computer program identifies a subset of the features or attributes indicative of fraud based on the weights;
the fraud detection computer program enriches the subset of the features or attributes;
the fraud detection computer program detects fraud based on the enriched subset of features or attributes; and
the fraud detection computer program notifies one or more subscribing institutions of a fraud event for the detected fraud based on the validated subset of features or attributes.

11. The system of claim 10, wherein the data comprises merchant data, acquirer data, issuer data, and/or payment network data.

12. The system of claim 10, wherein the fraud detection computer program anonymizes the normalized data.

13. The system of claim 10, wherein the fraud detection computer program normalizes the data by converting the data into one or more vectors and scaling the vectors to a standardized unit.

14. The system of claim 10, wherein the fraud detection computer validates that the subset of the features or attributes are indicative of an acceptable fraud event.

15. The system of claim 14, wherein the subset of the features or attributes are validated using dispute data, auxiliary fraud data, card scheme dispute data, and/or historical consortium data.

16. The system of claim 10, wherein the subset of the features or attributes are enriched with historical data relating to an issuer, a merchant, an acquirer, an/or a type of financial instrument.

17. The system of claim 10, wherein the data is received from a common data repository.

18. The system of claim 10, wherein the data is received from a distributed ledger network.

19. A non-transitory computer readable storage medium, including instructions stored thereon, which when read and executed by one or more computer processors, cause the one or more computer processors to perform steps comprising:
receiving data from a plurality of sources, each data associated with a unique identifier, wherein the data comprises merchant data, acquirer data, issuer data, and/or payment network data;
normalizing the data by converting the data into one or more vectors and scaling the vectors to a standardized unit;
modeling the normalized data with a trained machine learning data model;
extracting features or attributes from the modeled data;
generating one or more sets of weights for the features or attributes;
identifying a subset of the features or attributes indicative of fraud based on the weights;
enriching the subset of the features or attributes with historical data relating to an issuer, a merchant, an acquirer, an/or a type of financial instrument;
detecting fraud based on the enriched subset of the features or attributes; and
notifying one or more subscribing institutions of a fraud event for the detected fraud based on the validated subset of the features or attributes.

20. The non-transitory computer readable storage medium of claim 19, further including instructions stored thereon, which when read and executed by one or more computer processors, cause the one or more computer processors to perform steps comprising:
anonymizing the normalized data.
